(19) United States
(12) Patent Application Publication
(10) Pub. No.: US 2014/0136937 A1
(43) Pub. Date: May 15, 2014

(54) PROVIDING AND PROCURING WORKSHEET FUNCTIONS THROUGH AN ONLINE MARKETPLACE

(71) Applicant: MICROSOFT CORPORATION, Redmond, WA (US)

(72) Inventors: Keyur Rahul Patel, Seattle, WA (US); Daniel Chapman Battagin, Bellevue, WA (US)

(73) Assignee: MICROSOFT CORPORATION, Redmond, WA (US)

(21) Appl. No.: 13/672,707

(22) Filed: Nov. 9, 2012

(51) Int. Cl. G06F 17/00

(52) U.S. Cl. 715/212

(57) ABSTRACT

Methods and systems are provided for procuring functions, including Web service functions, for use in a spreadsheet application. A Web service function manifest can be managed by a function marketplace. A client device running a spreadsheet application can request available functions from the function marketplace. Information about available functions can be received by the client device. A selection of a function can be made in order to receive the manifest associated with the selected function. A local copy of the manifest may be stored for repeated invocation.

### BACKGROUND

Web services are gaining increasing popularity; and an increased acceptance of representational state transfer (REST)-based Web services has brought about an easier to use, resource-oriented model to expose those services. Being able to harness these sources of information is becoming of interest to many data consumers. It can be desirable to be able to incorporate real time data, such as stock prices and weather statistics, into a spreadsheet so that a user may act upon and organize the real time data using the functionality of a spreadsheet.

Currently there are tools in development for those with advanced knowledge of REST application programming interface (API)—enabled Web services and extensible markup language (XML) queries. These tools facilitate the creation of custom programs invoking Web services that may be used within software applications including spreadsheet applications and the like. However, it is desirable to enable any user—including those without specific understanding of Web services—to take advantage of the advances of Web services and incorporate publicly available data sources into their work product.

### BRIEF SUMMARY

A function marketplace and methods and systems for procuring custom worksheet functions from a function marketplace are provided. Functions can be requested from a central manifest location. The function marketplace can be available online or as a combination of online and offline (e.g., at least a portion of the items available through the marketplace are pre-seeded and/or cached locally). In certain embodiments, the function marketplace can be a public software marketplace in that the marketplace is publically available. In other embodiments, the marketplace can be a private marketplace, for example, only accessible behind a corporate firewall.

According to one aspect, Web service functions are provided to a general user of a spreadsheet application by calling a “well known web function.” Instead of relying on the user to discover a location of a particular Web service (e.g., the uniform resource location (URL)) and expecting the user to understand how to query and parse the response, the user can enter a Web service function in a same manner as entering a traditional spreadsheet function, such as a math function, logical function, or a text function.

According to another aspect, an online repository of web functions is provided in which manifest files describing a Web service can be made available for purchase and/or use by users. A spreadsheet application can be configured to connect to the online repository and retrieve a list of available Web functions (such as through a Public Marketplace or an App Catalog). Upon receiving a selection from a user, the spreadsheet application can request and store a manifest of the selected Web function. During a call to a Web service, the permission to use the web function can be verified.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1B show an operating environment in which embodiments of the invention may be practiced.

FIG. 2 shows a flow diagram illustrating aspects of a method of procuring worksheet functions according to an embodiment of the invention.

FIG. 3 shows a process flow in accordance with an embodiment of the invention.

FIGS. 4A-4B show an example system and user interface diagrams on which certain embodiments of the invention may be carried out.

FIG. 5 shows an example system on which certain embodiments of the invention may be carried out.

FIG. 6 shows an illustrative example involving a representative spreadsheet in which functions of certain embodiments of the invention are used.

FIG. 7 shows an illustrative example involving a representative spreadsheet in which functions of certain embodiments of the invention are used.

FIG. 8 shows a user interface diagram for authentication of a marketplace function in accordance with an embodiment of the invention.

FIG. 9 shows a diagram of a calculation process and validation in accordance with an embodiment of the invention.

FIG. 10 shows a block diagram illustrating components of a computing device used in some embodiments.

### DETAILED DESCRIPTION

A function marketplace and methods and systems for procuring custom worksheet functions from a function marketplace are provided. Functions can be requested from a central manifest location. The function marketplace can be available online or as a combination of online and offline (e.g., at least a portion of the items available through the marketplace are pre-seeded and/or cached locally). In certain embodiments, the function marketplace can be a public software marketplace in that the marketplace is publically available. In other embodiments, the marketplace can be a private marketplace, for example, only accessible behind a corporate firewall.

In accordance with embodiments of the invention, a marketplace of spreadsheet workbooks and stand-alone functions that contain calls to publicly available data sources such as REST API sources is provided. These stand-alone functions can be referred to as Web service functions (or Web functions). Web service functions can be associated with the workbooks and enable a user who is comfortable with entering functions the ability to query (discover) available functions in a store or catalog.

According to some embodiments, a user can call a Web service function in a same way as any other function within the spreadsheet application—an advanced knowledge of Web services or Web service functions is not necessary.

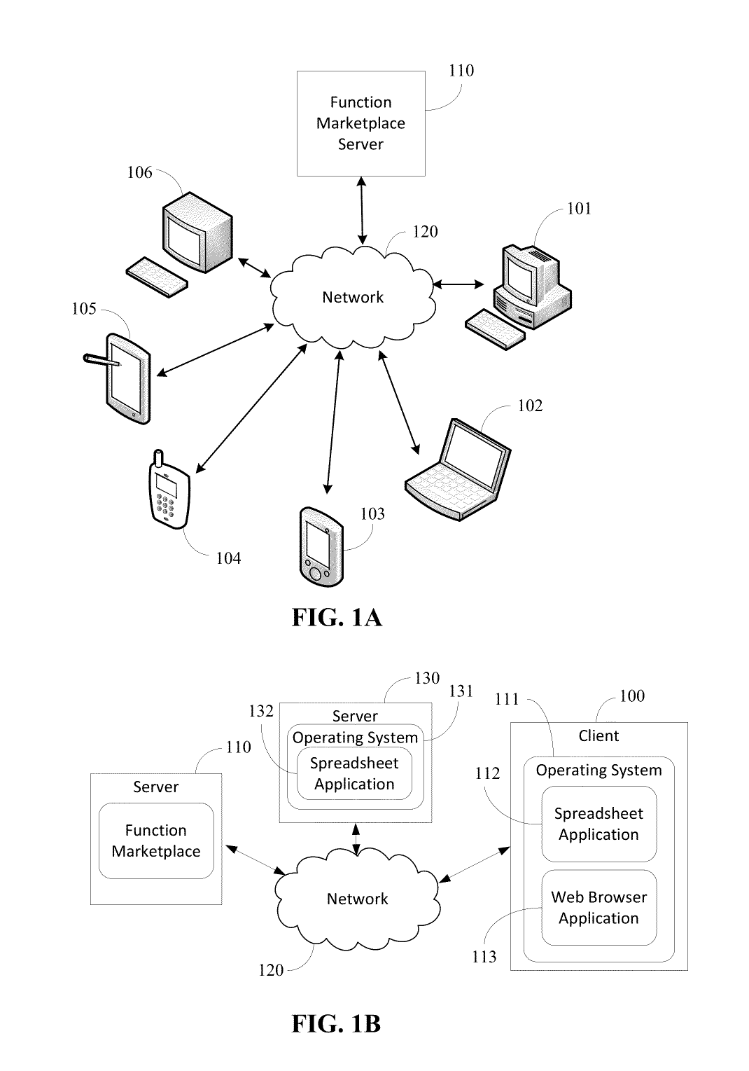

FIGS. 1A and 1B show an operating environment in which embodiments of the invention may be practiced. Referring to FIGS. 1A and 1B, a client device 100, including, but not limited to, a personal computer 101, laptop 102, personal digital assistant (PDA) 103, mobile phone (or smart phone) 104, tablet 105, or terminal 106, may be used to access a function marketplace server 110 over a network 120.

In accordance with certain embodiments of the invention, the network 120 may be an internet, an intranet, or an extranet, and can be any suitable communications network including, but not limited to, a cellular (e.g., wireless phone) network, the Internet, a local area network (LAN), a wide area network (WAN), a WiFi network, or a combination thereof Such networks may involve connections of network elements, such as hubs, bridges, routers, switches, servers, and gateways.

The network 120 may include one or more connected networks (e.g., a multi-network environment) including public networks, such as the Internet, and/or private networks such as a secure enterprise private network. Access to the network 120 may be provided via one or more wired or wireless access networks (not shown), as will be understood by those skilled in the art. As will also be appreciated by those skilled in the art, communication networks can take several different forms and can use several different communication protocols.

Communication between computing devices in a client-server relationship may be initiated by a client sending a request to the server asking for access to a particular resource or for particular work to be performed. The server may subsequently perform the actions requested and send a response back to the client.

The client(s) 100 and the servers 110, 130 can involve computing systems configured with one or more central processing units (CPUs), memory, mass storage, and I/O devices (e.g., network interface, user input device). Elements of the computing system can communicate with each other via a bus. The hardware platform of computing systems can be embodied in many forms including, but not limited to, a personal computer, a server computer, a hand-held or laptop device, a multiprocessor system, a microprocessor-based system, programmable consumer electronics, and a distributed computing environment that includes any of the above systems or devices.

In certain embodiments, the client 100 can be embodied as a computing device including, but not limited to, a personal (desktop) computer 101, a laptop (or notebook or netbook) computer 102, a PDA 103, a mobile phone 104, a tablet 105, a gaming device or console (not shown), a user terminal 106, or a smart television (not shown).

In certain embodiments, the function marketplace server 110 and/or server 130 can be embodied as a computing device including, but not limited to, a server computer, an enterprise computer, a personal computer, a multiprocessor system, a microprocessor-based system, and a combination thereof It should be understood that the listing of client computing devices and the server computing devices is not intended to be limiting and that the client and server may be embodied in the same or different form and include physical and/or virtual components.

The client computing device 100 is configured to execute an operating system 111 and one or more application programs such as, in the illustrated embodiment, a spreadsheet application 112, a web browser application 113, and/or one or more other applications.

The operating system 111 is a computer program for controlling the operation of the client computing device 100. The application programs are executable programs configured to execute on top of the operating system 111 to provide various functionality such as described herein. The spreadsheet application 112 is an application program configured to receive and display data in cells in a simulated worksheet of rows and columns. One or more formulas can be applied to all or a portion of the data to perform calculations, filtering, and other analysis. The data can alternatively or additionally be used as the basis for creating tables, charts, sparklines (a simplified line chart), and other visualizations.

The web browser application 113 is an application program for retrieving and traversing information resources on the World Wide Web (“the Web”), as well as resources provided by web servers in private networks via the network 120, and presenting the information resources to a user (e.g., rendering for display). Moreover, the web browser application 111 allows a user to access information and various functions provided by a server.

The illustrated server computer 130 is configured to execute a server operating system 131, one or more application programs such as a server spreadsheet application 132, and/or one or more other applications.

The server operating system 131 is a computer program for controlling the operation of the server computing device 130, and the application programs are executable programs configured to execute on top of the server operating system 131 to provide various functionality described herein. The server spreadsheet application 132, in some embodiments, is a web-based application program configured to receive and display data in cells in a spreadsheet document such as a worksheet. In some embodiments, the server computer 130 is configured to execute the server spreadsheet application 132 and the client computing device 100 is configured to access the server computer 130 to interact with the server spreadsheet application 132 in a client/server configuration. In these embodiments, the server spreadsheet application 132 may provide functionality that is identical to the spreadsheet application 112.

In one embodiment, the client web browser application 111 is used to connect with a server, for example, server computing device 130, in order to access a web-based spreadsheet application 132.

It should be understood that multiple client computing devices, multiple networks, and/or multiple servers may be included as part of the operating environment.

The function marketplace 110 can be accessed by an application running on the client device 100 or viewed within an application running on a client device 100. In one embodiment, a spreadsheet application (e.g., spreadsheet application 112, 132) communicates with the function marketplace 110. The spreadsheet application may be running on the client device 100 or on a server 130 and then viewed on the client device through a web browser application (e.g., web browser application 113) running on the client device 100 (or through a specific client application interface). Server 130 and/or the client device 100 can communicate with the function marketplace server 110 through an application programming interface (API).

The API may be incorporated to provide a software-to-software interface that enables applications to communicate over the network 120.

An API is generally a set of programming instructions and standards for enabling two or more applications to communicate with each other and is commonly implemented as a set of Hypertext Transfer Protocol (HTTP) request messages and a specified format or structure for response messages. The messages can contain an information resource. A resource is information that can be identified by a uniform resource identifier (URI) and may be a file, a dynamically-generated query result, the output of a common gateway interface (CGI) script, a document that is available in several languages, and the like.

Common formats for the messages include an Extensible Markup Language (XML) and JavaScript Object Notation (JSON) format. The requests and responses (e.g., the calls back and forth between applications) according to an API can be managed through Web services.

A Web service is a software system that supports interoperable machine-to-machine interaction over a network and enables software to connect to other software applications. A Web service provides a collection of technological standards and protocols. The Web service provides functions that may be implemented by a software or hardware agent that sends and receives messages (e.g., the computing platforms requesting and providing a particular service). Web services are readily available sources of information across the web today. Many web sites offer REST compliant Web services as part of their public API offerings.

REST refers to a web architecture that governs the behavior between clients and servers of a distributed system such as the Web. In general, a RESTful Web service presents a uniform interface between clients and servers and may be implemented using, for example, HTTP, XML, and JSON. Instead of requiring a well-defined message to a particular resource, REST may simply request a specific resource.

A Web service, including that associated with the function marketplace server, may be implemented using one or more physical and/or virtual servers communicating over network 120. Applications running on client 100 and server 130 can access Web services via ubiquitous Web protocols and data formats such as HTTP, XML, JSON and SOAP.

Embodiments facilitate the use of web content in spreadsheet applications through the use of functions that get web content and convert the web content into usable data. Instead of requiring custom coding for a user to get live web data from a publicly available Web service, embodiments provide Web service functions from within a spreadsheet application. This enables a user to bring live web data into the spreadsheet application where the data can be manipulated and displayed using the tools available within the spreadsheet application.

In accordance with embodiments of the invention, developers may create custom functions for spreadsheet and other applications for sharing with users of those applications. For example, developers may utilize a macro to create code in visual basic for applications (VBA) for a specific function. VBA is a software tool for creating macros, procedures and custom functions that may be used in spreadsheet applications such as MICROSOFT EXCEL, a registered trademark of Microsoft Corp. Developers may also utilize the functions described in co-pending application Ser. No. ______ (Attorney Docket No. 337171.01) entitled “Spreadsheet Functions to Call REST API Sources,” which is hereby incorporated by reference.

The custom functions created by developers can be shared through a function marketplace in accordance with embodiments of the invention. The function marketplace can be associated with a central manifest location (which stores or points to stores of function manifests). In certain embodiments, the function marketplace may be integrated with existing stores or trusted application catalogs such as the GOOGLE Apps Marketplace; WINDOWS Marketplace; Apps for OFFICE and SHAREPOINT (e.g., Office Store), AMAZON Appstore, and the APPLE APP STORE.

In one embodiment, a function marketplace application can include hooks for REST enabled endpoints, facilitating the inclusion of custom functions that call Web services. An endpoint indicates the specific location where a service can be accessed by using a specific protocol and data format. A hook is a fixed interface that enables extended functionality of an application, including to add new URLs and pages, content, and database tables without requiring additional code to be written to enable integration with a third party data source. In certain embodiments, the function marketplace application hosts a manifest of a function. The function can be used in applications for multiple environments and clients, including desktop, mobile, Web, on-premises, and in the cloud.

Embodiments of the invention provide a function marketplace. Discovery of REST API enabled Web services to query remains a challenge due to lack of centralized listing services. The function marketplace can provide a central listing for Web services, which can facilitate the discovery of REST API enabled Web services.

In one embodiment, the function marketplace can be used to advertise and monetize Web services specifically for spreadsheet applications.

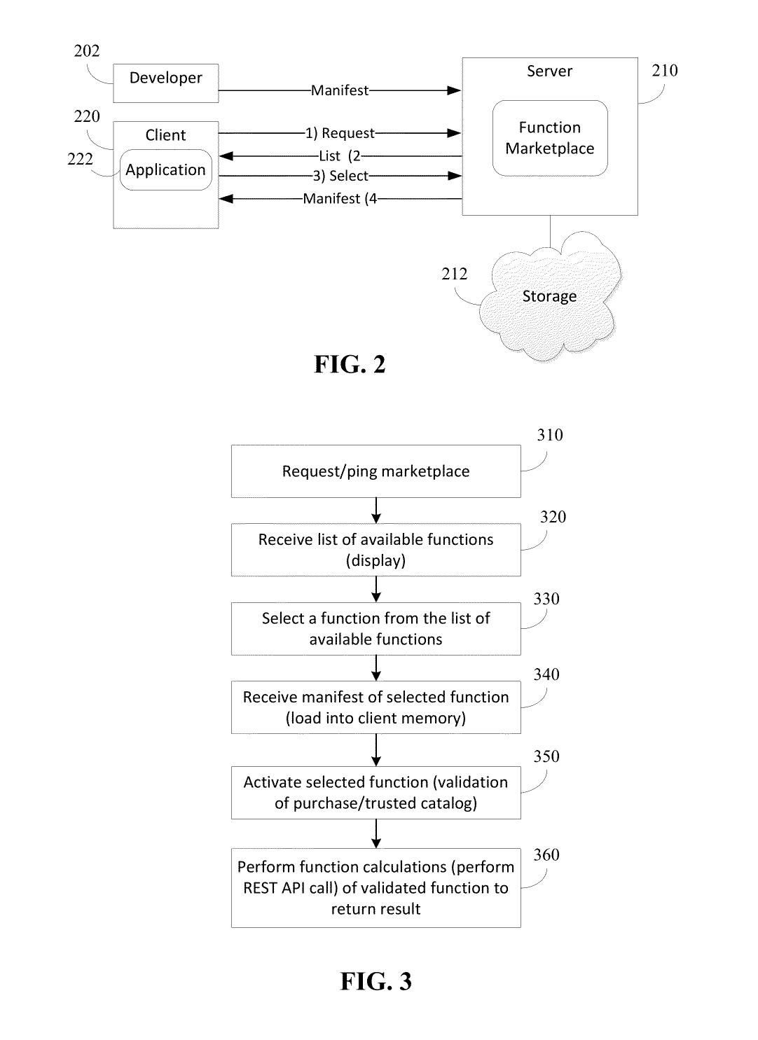

Referring to FIG. 2, a developer (via a developer's computing device 202) can provide their custom function to the function marketplace 210 by submitting a manifest to the function marketplace.

A manifest is a file that provides information regarding an application and/or content for an application. Often the manifest is in XML, but can be provided as any appropriate media type—also known as a multipurpose Internet mail extension (MIME)—type. A manifest presents information regarding its content or application that is used by a system to execute code related to the content or application. A manifest generally includes a unique name to identify the application and one or more components, including, but not limited to, the activities, services, permissions, and component classes and capabilities.

When providing an application to an app marketplace, a webpage may also be included with the manifest in order to implement a user interface and custom logic. However, for certain embodiments of the functions procured through the function marketplace, only a manifest is provided to the function marketplace server 210. The manifest can be stored in a storage 212 that may be associated with the function marketplace. The storage 212 can be a cloud-based storage.

Once the manifest is accepted by (and hooked into) the function marketplace, a client device running an application 222 can communicate with the function marketplace server 210 in order to obtain a function. Once a function is obtained the function can be considered a “known” function.

In accordance with an embodiment of the invention, an application 222 such as a spreadsheet application (or other application that may utilize the functions described herein) can locate known functions by querying a manifest file, which can be stored locally on the client device or on http://locations, such as a company's web application platform for content management. An example of a platform that may be used in this manner is SHAREPOINT, a registered trademark of Microsoft Corp. A “known function” refers to a function that a user has agreed and trusted to use. In operation, by being labeled a “known function,” a user may more readily use the function, for example, by not having to insert the function again as part of the spreadsheet application and/or by not being prompted each time about whether the user agrees to use the function.

The manifest file location is queried in order to populate a list presented to a user with a set of known functions. If the manifest is stored on an http location, a local copy may be cached. The function definition can be stored within the document itself. Accordingly, opening a document with a function call will load the function information from the sheet and allow a re-calculation to complete.

FIG. 3 shows a process flow in accordance with an embodiment of the invention. A client can request or “ping” the function marketplace or application catalog to request a listing of available functions at a central manifest location (310). A list of available functions stored in association with the function marketplace can be received by the client and displayed on the client computing device (320). A selection can be made of a function from the list of available functions (330) and a manifest of the selected function can be received and stored in client memory (340). These four steps are shown in FIG. 2 interactions between the client device 220 and the marketplace server 210. In certain embodiments, functions received by the client may be stored and shown as available to a user according to a user's credentials (sign-in or account information).

Once the client has a function manifest stored locally in memory, an activation/validation of the function may be carried out upon use of the function within a program (350).

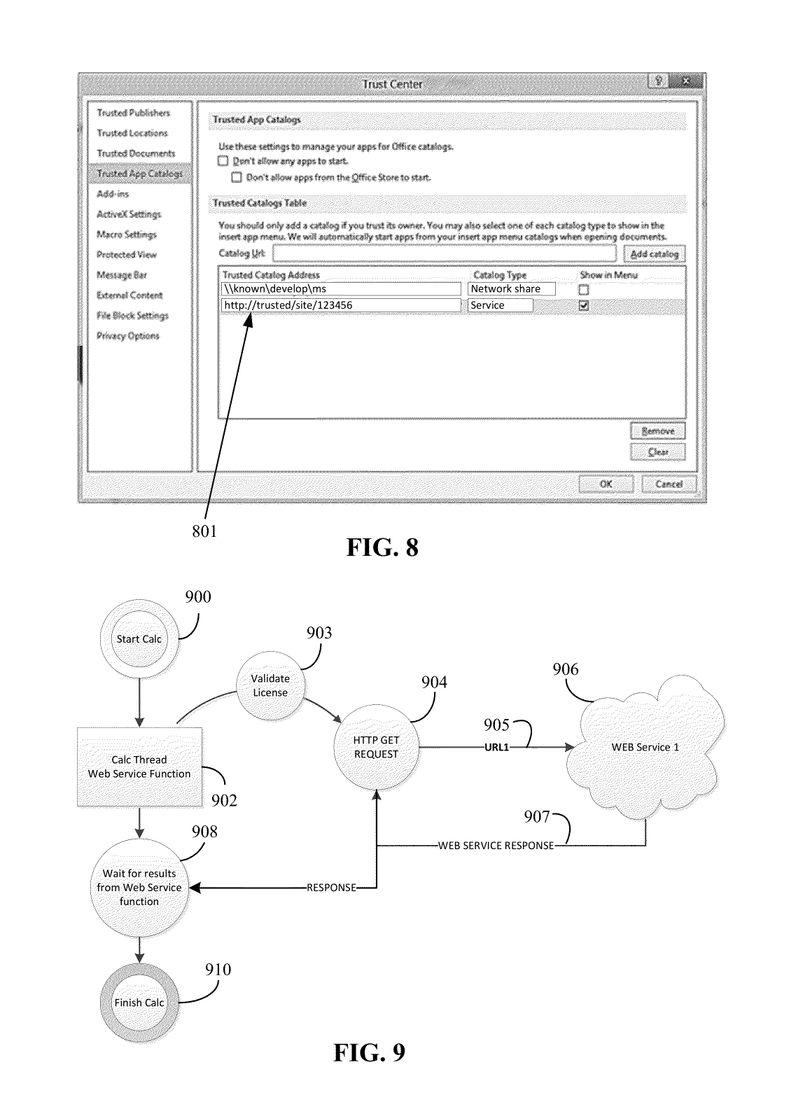

For Web service functions, performing the function calculations (360) invokes a Web service. Invoking a Web service refers to the actions that a client application performs to use (and/or “call”) the Web service (see FIG. 8). The call to a Web service may be referred to as an invocation. A client application can be a stand-alone client that invokes a Web service hosted on an application server or another Web service. As part of an invocation, a client contacts a Web service (in the server) and sends a service request. The server returns the requested information/service through a service response.

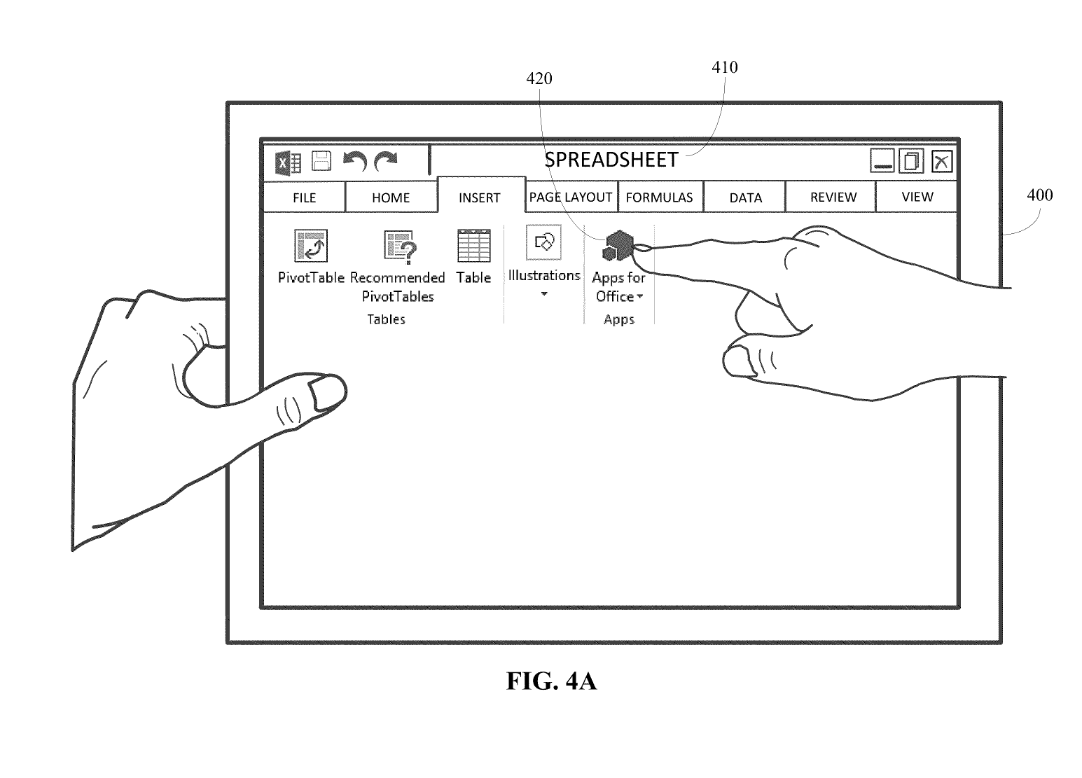

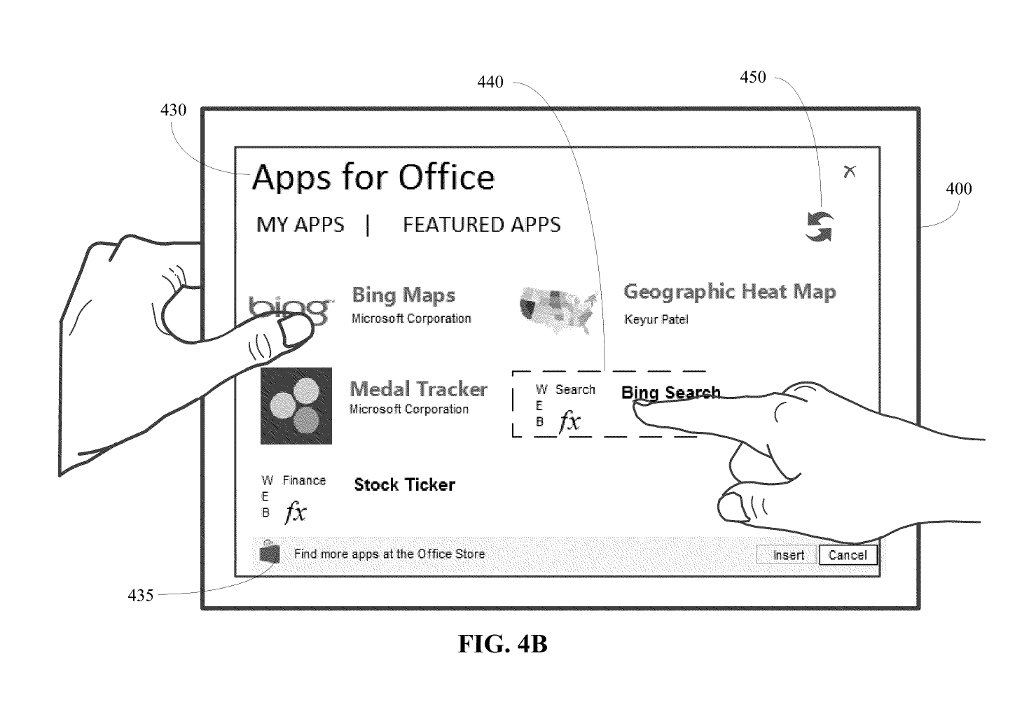

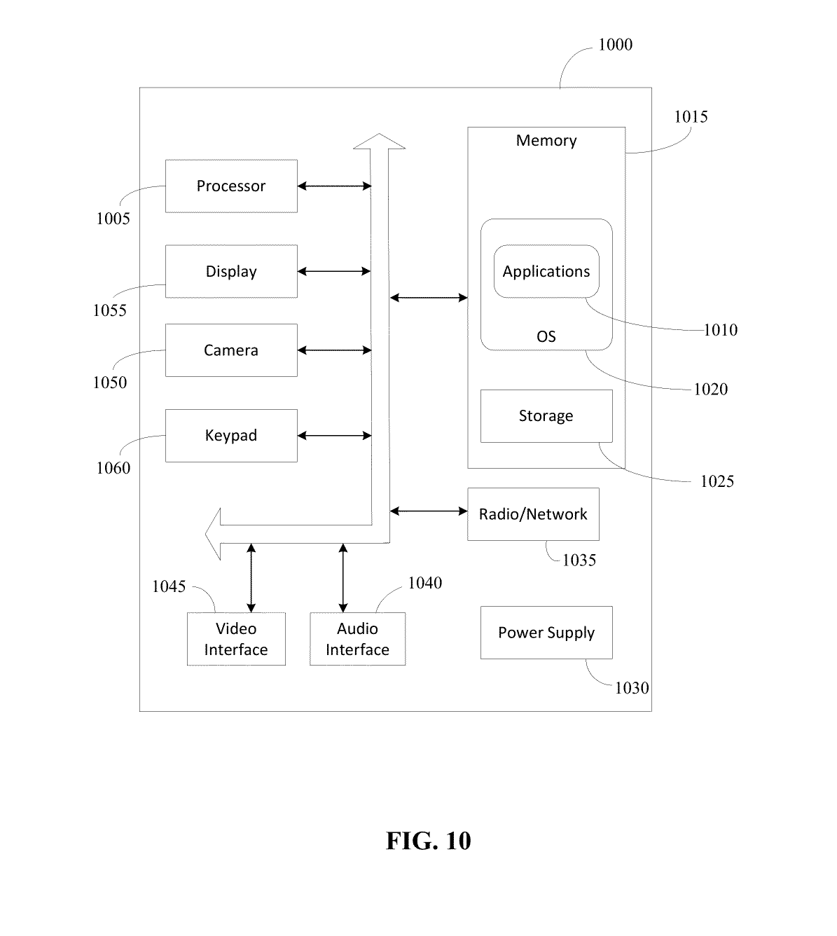

FIGS. 4A and 4B show an example system and user interface diagrams on which certain embodiments of the invention may be carried out. Referring to FIG. 4A, a client computing device, such as a tablet 400 can display a spreadsheet application 410 that may be a spreadsheet application running on the device 400 or a spreadsheet application running on a server and accessed through a web browser application running on the device 400. The computing device 400 can include components as described with respect to FIG. 10. In one embodiment, a user may access a function marketplace through a button in the spreadsheet application.

In one implementation, a button can be provided in the spreadsheet application to open a window directly to the function marketplace store. In another implementation, a button can be provided to open a window containing a user's current custom functions and/or applications and a second button can be provided within the window to access the function marketplace store. A “function” is a type of application in which a result is calculated based on one or more input values, which are also referred to as arguments. The button(s) for accessing the available functions and/or the function marketplace store may be available through a menu, drop-down box, ribbon, or the like.

An insert function module may be provided as part of a spreadsheet application. The insert function module can provide an interface by which a user requests to insert a function. For example, the insert function module can display a list of available Web functions in response to receiving an insert function request from a user, and communicate with an online marketplace to receive a manifest of a selected one of the available Web functions.

In a specific implementation in which a MICROSOFT EXCEL spreadsheet application is used, an insert Apps for Office button 420, for example, as illustrated in FIG. 4A, may be used to access the user's add-on and custom apps and functions. When a user selects the Insert>Apps for Office button, a dialog that shows the various apps and functions available to the user can be launched as shown in FIG. 4B. According to an embodiment, when the Apps for Office button 420 is selected, a manifest file location associated with the user's account is queried in order to populate a list presented to a user with a set of known functions. For example, a user may be presented with a combination of available applications and functions as their available Apps for Office 430 as shown in FIG. 4B. The Office Store can then be accessed by a button 435 on the window containing the user's Apps for Office 430. In certain embodiments, the functions may be presented to the user separate from the apps.

From within the insert function dialog shown in FIG. 4B, a user can click on a help link to bring up the developer's specified help article from a browser. Function apps can be refreshed through, for example, a refresh button 450.

When the user clicks the refresh button 450, the spreadsheet application can query and cache the manifest locally. Upon launch of the spreadsheet application (and/or on boot), the spreadsheet application can load functions from a cached manifest to incorporate the functions as built-in functions or any other user defined functions. For the application running on a server, functions can be retrieved from a manifest location on a web application platform such as a SHAREPOINT site. Similarly, a global manifest can be provided through a cloud service such as MICROSOFT SKYDRIVE, a registered trademark of Microsoft Corp.

From the manifest, metadata about previously acquired function apps can be cached on the user's client device. By caching the metadata, the application (such as spreadsheet application 410) can load the metadata of the functions offline and facilitate autocomplete or insert function entry points. An acquired app or function can be included in a function autocomplete so that the user may access the acquired functions without having to launch the insert function dialog. A “function autocomplete” refers to a user interface shown in a spreadsheet application that helps an end user correctly enter the function name and parameters for the function.

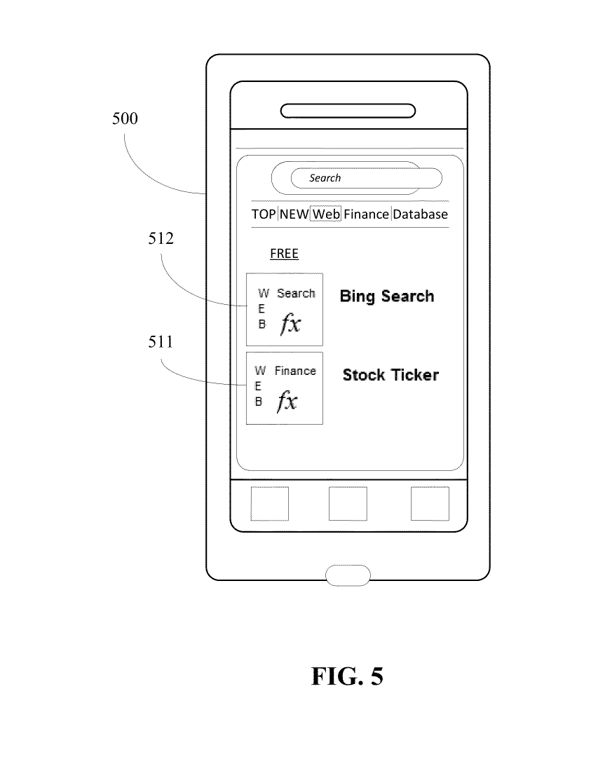

In the example shown in FIG. 4B, the user's account has two functions that may be used (e.g., executed) in a spreadsheet application—a Stock Ticker function and a Bing Search function. BING is a registered trademark of Microsoft Inc. The user may have purchased the functions from a function marketplace, such as shown in FIG. 5. FIG. 5 shows an example system on which certain embodiments of the invention may be carried out. Referring to FIG. 5, a client computing device, such as a smart phone 500, can display a function marketplace application. The computing device 500 can include components as described with respect to FIG. 10.

A user may have an account (either associated with a spreadsheet application or as part of a software suite) through which one or more functions may be purchased. For example, during a prior session within a mobile version of the spreadsheet application shown in FIG. 4A, the user may have launched to a function marketplace such as shown in FIG. 5 to have a list of available functions displayed. The displayed functions may be grouped for ease of searching. The groups can include, but are not limited to, new functions, popular functions, free functions, math functions, and Web functions. A search of Web service functions may have returned the Stock Ticker 511 and the BING search 512 functions. The user can select the functions and receive a manifest of the selected function(s) to be stored in a memory cache associated with the user's account and/or locally on the client device.

In accordance with embodiments of the invention, by using “known” functions the user can insert a Web service function without knowledge of a Web service location (e.g., URL) or how to parse the results returned by the Web service.

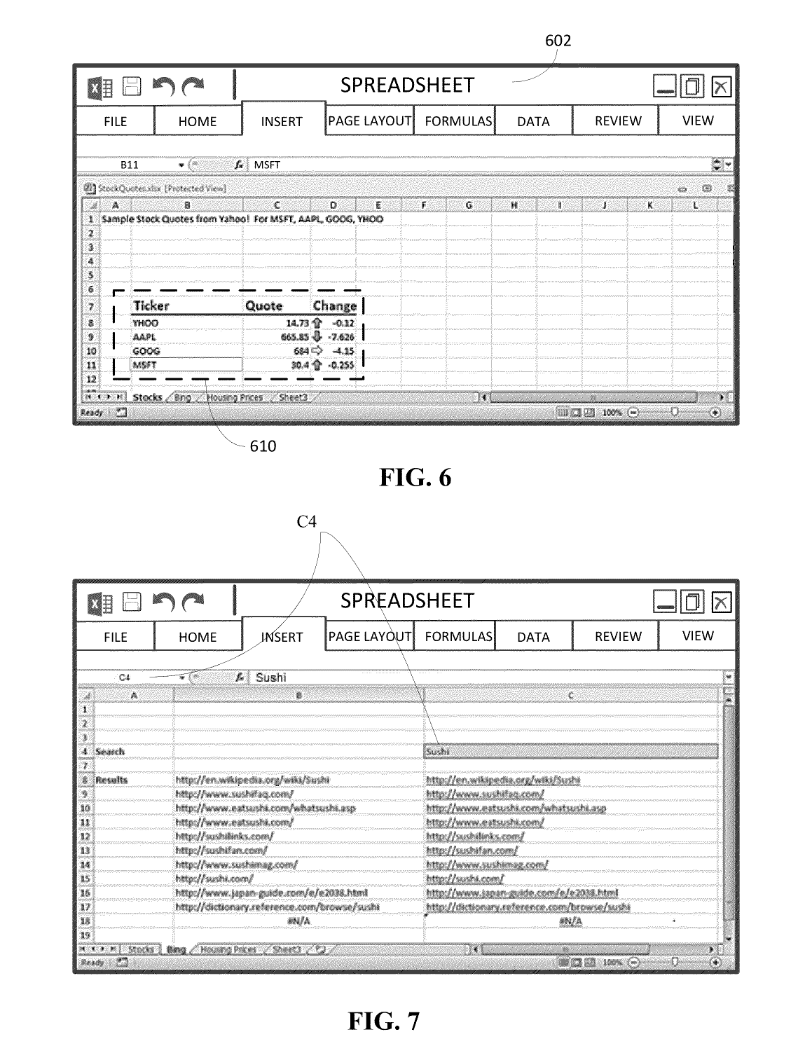

In the example of FIG. 6, the Web service function “Stock Ticker” of an embodiment of the invention can be used within the spreadsheet application 602 to get stock quotes and display the quotes in a table 610. The “Stock Ticker” function may appear as “=FINANCE(stockTicker, . . . )”. The particular arguments of the function obtained through the function marketplace can be defined in the manifest and presented as part of an autocomplete or through an insert function wizard. For the Stock Ticker function, the argument can be one or more ticker names. In the example of FIG. 6, quotes are obtained for Microsoft Corp. (MSFT), Apple Inc. (AAPL), Google Inc. (GOOG), and Yahoo! Inc. (YHOO).

FIG. 7 shows a worksheet of a spreadsheet application 702 in which a Web service function for performing a search query on a search engine is inserted in order to obtain and display search results within the spreadsheet application. The Web service function shown in FIG. 7 can take a search term and the number of results to be retrieved as an argument. The “Bing Search” function may appear as “=SEARCH(searchTerm, numberofResults) For example, a search term of “Sushi” may be received by the spread sheet in a cell C4 and the Web service function inserted from the function marketplace can use the term(s) received in the cell to call the BING Web service and return a number of search results (e.g., 10). The function may call http://schemas.microsoft.com/LiveSearch using “sushi” as a search term (by passing the query through the Web service call) and then automatically filter the results to present an array of URLs (uniform resource locators) within the spreadsheet application.

In accordance with various embodiments, function-based apps incorporating Web service calls use rules described by a manifest schema definition (loaded in memory at the activation of the function) to make the relevant REST API call. Once the call has been made, the results can be parsed using a filter string specified within the manifest and the result returned to the spreadsheet application, which then can be used in other calculations in the spreadsheet.

For the example function “=SEARCH(searchTerm, numberofResults)”, the Web service call can include a URL for =SEARCH(“Sushi”, 5) as “http://api.bing.net/xml.aspx?AppId=&Version=2.2&Market=en-US&Query=Sushi&Sources=web+spell&Web.Count=1”. An example function manifest (in XML) can include features as follows:

<webfunctions>
<function>

<name>SEARCH</name>
<description>This Web function allows to you to Search on

Bing!</description>

<webServiceURL> http://api.bing.net/xml.aspx</webServiceURL>
<helpLink> www.bing.com/BingExcelFunction </helpLink>
<type>XML</type>
<filter>//url</filter>

In the above section, elements of name, description, Web service URL, help link, filter, and response type are included. The help link can be presented as part of an autocomplete or through an Insert Function Wizard in order to provide a link for a user to click through to obtain help regarding a particular function. The filter presents the Xpath that may be used to parse the function. The response type indicates the format of the response and may be XML, JSON, or another markup language or image.

An AppID key with value may be included to facilitate remapping a call whenever a call is made using “=SEARCH(”Sushi“, 5)”. The “AppID” provides an identifier of the function calling the Web service.

The manifest can further include definitions for the arguments. For the example function “=SEARCH(searchTerm, numberofResults)”, the manifest can include the following:

<arguments>

<argument>

<name>search</name>
<description>enter what you want to search for</description>
<webServiceParamKey>query</webServiceParamKey>

</argument>
<argument>

<name>resultCount</name>
<description>resultCount</description>
<webServiceParamKey>count</webServiceParamKey>

</argument>

</arguments>

In the above section, two arguments are described, “query” and “count”. In an autocomplete or Insert Function Wizard, the description can be displayed to explain what the argument is to be filled.

Multiple functions may be included in a manifest. For example, a single manifest may include service calls for stocks, weather, and traffic.

FIG. 8 shows a user interface diagram for authentication of a marketplace function in accordance with an embodiment of the invention. According to one embodiment, a user receiving a workbook with a function-based app can be prompted to trust the function. When a user indicates that the function is “trusted”, the user can avoid being prompted to validate that the user wants the function to be executed (and perform calculations) each time the function is called from within a spreadsheet. Trusted functions can be part of a user's “known” functions.

For embodiments where the functions are provided without a user interface (by being presented as the function that can be applied to a cell or cells), an information bar such as shown in FIG. 8 can be displayed, requesting that the user enables content. The information bar can include information regarding the various function apps that exist in the document and the ability for the user to trust all or individually trust various function apps. As shown in FIG. 8, a trusted catalog table 801 can present the addresses of the functions that are considered to be trusted. The trusted apps can be maintained on, for example, a SHAREPOINT site, on a network share, or a cloud-based catalog.

Because function based apps of some embodiments are not executed using a web browser engine in order to display content on a screen, for these embodiments, the spreadsheet application can ping the Trusted App Catalog (such as presented in FIG. 8) to determine if the function may be executed. In certain embodiments activation can occur when a function app is calculated for the first time during a session.

FIG. 9 shows a diagram of a calculation process and validation in accordance with an embodiment of the invention. For custom functions that call a Web service, the calculations can be accomplished according to rules described by the manifest schema definition (loaded in memory at activation) in order to make a relevant REST API call. Once the call has been made, the results can be parsed using a specified filter string and the results are returned to the application. Multiple Web service requests can be initiated and the Web service functions can be implemented as built-in thread-safe, asynchronous user defined functions on both client/server. In some embodiments, when applying a custom function in a spreadsheet application, a call to a Web service involves validating the license. The validation may occur during a first call or during first and subsequent calls. Activation can occur when the function is calculated for the first time during a session.

Once the function is validated, an HTTP GET request can be instantiated using the URL string provided with the manifest for the function (sheet data from other cells may also be appended and/or passed through the URL). The HTTP GET request interfaces with the Web service at the URL and receives a response from the Web service. The spreadsheet system waits for the results from the Web service. Because the requests are made asynchronously, multiple requests and main thread formula calculations can be initiated while the spreadsheet application is waiting for results.

For example, a calculation process can begin (900) to calculate a first thread (902). The licensing for the function is validated (903) and an HTTP GET request is initiated (904). During validation of the license (903), existing licensing mechanisms may be utilized. For example, an OATH token may be used to validate a signed-in user against a particular Web service. The token may be sent by the spreadsheet application to a developer's website so that the developer may authenticate the user. If the user has not been authenticated, the developer can either pass back an error message or return an error.

The HTTP GET request retrieves whatever information (in the form of an entity) is identified by the Request-URI url1 (905) from the manifest. If the Request-URI refers to a data-producing process, it is the produced data that is returned from the Web service 1 (906) as the entity in the response (907) and not the source text of the process, unless that text happens to be the output of the process.

Other functions may be calculated as part of the calculation process while waiting for the result response (907) from the Web service call. Once the results are received (908), the calculations can be completed (910). Once the calculations are complete, the data can be displayed within the spreadsheet.

FIG. 10 shows a block diagram illustrating components of a computing device used in some embodiments. For example, system 1000 can be used in implementing a desktop or notebook computer or a tablet 400 or smart phone 500 that can run one or more applications similar to those of a desktop or notebook computer such as, for example, browser, e-mail, scheduling, instant messaging, and media player applications. In some embodiments, system 1000 is an integrated computing device, such as an integrated personal digital assistant (PDA) and wireless phone.

System 1000 includes a processor 1005 that processes data according to instructions of one or more application programs 1010, including a spreadsheet application, and/or operating system 1020. The one or more application programs 1010 may be loaded into memory 1015 and run on or in association with the operating system 1020. Examples of application programs include the spreadsheet application, phone dialer programs, web conferencing programs, e-mail programs, personal information management (PIM) programs, word processing programs, spreadsheet programs, Internet browser programs, messaging programs, game programs, and the like. Other applications may be loaded into memory 1015 and run on the device, including various client and server applications.

System 1000 also includes non-volatile storage 1025 within memory 1015. Non-volatile storage 1025 may be used to store persistent information that should not be lost if system 1000 is powered down. Application programs 1010 may use and store information in non-volatile storage 1025, such as e-mail or other messages used by an e-mail application, and the like. A synchronization application may also be included and reside as part of the application programs 1010 for interacting with a corresponding synchronization application on a host computer system (such as a server) to keep the information stored in non-volatile storage 1025 synchronized with corresponding information stored at the host computer system.

System 1000 has a power supply 1030, which may be implemented as one or more batteries and/or an energy harvester (ambient-radiation, photovoltaic, piezoelectric thermoelectric electrostatic, and the like). Power supply 1030 might further include an external power source, such as an AC adapter or a powered docking cradle that supplements or recharges the batteries.

System 1000 may also include a radio/network interface 1035 that performs the function of transmitting and receiving radio frequency communications. The radio/network interface 1035 facilitates wireless connectivity between system 1000 and the “outside world,” via a communications carrier or service provider. Transmissions to and from the radio/network interface 1035 are conducted under control of the operating system 1020, which disseminates communications received by the radio/network interface 1035 to application programs 1010 and vice versa.

The radio/network interface 1035 allows system 1000 to communicate with other computing devices, such as over a network.

An audio interface 1040 can be used to provide audible signals to and receive audible signals from the user. For example, the audio interface 1040 can be coupled to a speaker to provide audible output and a microphone to receive audible input, such as to facilitate a telephone conversation. System 1000 may further include video interface 1045 that enables an operation of an optional camera (not shown) to record still images, video stream, and the like. Visual output can be provided via a touch screen display 1055. In some cases, the display may not be touch screen and a user input elements, such as buttons, keys, roller wheel, and the like are used to select items displayed as part of a graphical user interface on the display 1055. A keypad 1060 can also be included for user input. The keypad 1060 may be a physical keypad or a soft keypad generated on the touch screen display 1055.

It should be understood the any mobile or desktop computing device implementing system 1000 may have additional features or functionality and is not limited to the configurations described herein.

In various implementations, data/information stored via the system 1000 may include data caches stored locally on the device or the data may be stored on any number of storage media that may be accessed by the device via the radio/network interface 1035 or via a wired connection between the device and a separate computing device associated with the device, for example, a server computer in a distributed computing network, such as the Internet. As should be appreciated such data/information may be accessed through the device via the radio interface 1035 or a distributed computing network. Similarly, such data/information may be readily transferred between computing devices for storage and use according to well-known data/information transfer and storage means, including electronic mail and collaborative data/information sharing systems.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Computer-readable media can be any available computer-readable storage media or communication media that can be accessed by the computer system. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

It should be appreciated by those skilled in the art that computer-readable storage media include removable and non-removable structures/devices that can be used for storage of information, such as computer-readable instructions, data structures, program modules, and other data used by a computing system/environment. A computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. Computer-readable storage media should not be construed or interpreted to include any carrier waves or propagating signals.

Furthermore, in addition to being implemented as software, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A method comprising:
requesting available functions from a central manifest location, the functions comprising at least one Web service function;
receiving information indicating available functions;
requesting a selection of one of the available functions; and
receiving a manifest of the selected one of the available functions.

2. The method of claim 1, further comprising:
displaying a list of known functions by querying a local manifest file location and receiving the list of known functions from the local manifest file location, at least one of the known functions being received from the central manifest location.

3. The method of claim 1, the method further comprising:
sending an invocation of the function over a Web service in accordance with the manifest of the selected one of the available functions.

4. The method of claim 3, wherein the function comprises a representational state transfer (REST) application programming interface (API) Web service function.

5. The method of claim 3, wherein sending the invocation of the function over the Web service comprises:
executing the Web service function in a spreadsheet application;
validating a license of the Web service function;
performing a call and filter for Web service function having a valid license; and
returning results within the spreadsheet application.

6. The method of claim 5, wherein performing the call and the filter comprises:
performing a Web service request to a Web service uniform resource location (URL) presented in the manifest;
receiving a Web service response; and
performing filtering of the Web service response according to a schema of the manifest.

7. The method of claim 1, further comprising:
displaying the selected function in a spreadsheet application;
receiving an argument input in a cell of a spreadsheet; and
executing the selected function.

8. The method of claim 1, further comprising:
receiving a trust setting for the selected one of the available functions.

9. The method of claim 1, wherein the central manifest location comprises an online marketplace, wherein the information indicating available functions comprises a list of available Web service functions from the online marketplace.

10. The method of claim 9, further comprising:
displaying the list of available Web service functions at a client device, wherein the selected one of the available functions is a Web function selected via an input device of the client device.

11. The method of claim 10, further comprising:
storing the manifest in a manifest file in a cache associated with a spreadsheet application of the client device.

12. The method of claim 11, further comprising:
locating known functions in the manifest file; and
populating a list of known functions in the spreadsheet application.

13. The method of claim 11, further comprising:
displaying the selected Web function in a cell of the spreadsheet application;
receiving an argument in one or more cells of the spreadsheet application according to an argument description of the Web function from the manifest; and
calculating the Web function according to the argument.

14. The method of claim 13, wherein calculating the Web function according to the argument comprises:
verifying permission to use the Web function;
invoking a Web service at the Web service URL after verifying the permission;
filtering results received from the Web service according to the filter; and
displaying the filtered results in the spreadsheet application.

15. A computer-readable storage medium storing instructions that when executed perform a method comprising:
requesting at a client device a list of available Web functions from an online marketplace;
receiving the list of available Web functions from the online marketplace;
displaying the list of available Web functions at the client device;
receiving a selection of one of the available Web functions via an input device of the client device;
receiving a manifest of the selected one of the available Web functions from the online marketplace, the manifest comprising a Web service URL, filter, and argument description; and
storing the manifest in a manifest file in a cache associated with a spreadsheet application of the client device.

16. The medium of claim 15, wherein the method further comprises:
locating known functions in the manifest file; and
populating a list of known functions in the spreadsheet application.

17. The medium of claim 15, wherein the method further comprises:
displaying the selected one of the available Web functions in a cell of the spreadsheet application;
receiving an argument in one or more cells of the spreadsheet application according to the argument description; and
calculating the Web function according to the argument.

18. The medium of claim 17, wherein calculating the Web function according to the argument comprises:
verifying permission to use the Web function;
invoking a Web service at the Web service URL after verifying the permission;
filtering results received from the Web service according to the filter; and
displaying the filtered results in the spreadsheet application.

19. The medium of claim 15, wherein the method further comprises:
receiving a trust setting for the selected one of the available Web functions.

20. A system for providing web service functions within a spreadsheet application, the system comprising:
an insert function module configured to:
receive an insert function request from a user,
display a list of available Web functions from an online marketplace, and
receive a manifest of a selected one of the available Web functions from the online marketplace, the manifest comprising a Web service URL, filter, and argument description; and
a local cache for storing the manifest.
